(19) United States
(12) Patent Application Publication
(10) Pub. No.: US 2025/0252004 A1
(43) Pub. Date: Aug. 7, 2025

(54) PERFORMING HARDWARE FAILURE DETECTION BASED ON MULTIMODAL FEATURE FUSION

(71) Applicant: Microsoft Technology Licensing, LLC, Redmond, WA (US)

(72) Inventors: Huanghao Xu, Suzhou (CN); Di GUO, Suzhou (CN); Fengjie DENG, Suzhou (CN); Junjun SANG, Suzhou (CN); Nicholas John Vernon THOMPSON, Sammamish, WA (US)

(21) Appl. No.: 18/695,074

(22) PCT Filed: Oct. 26, 2021
(86) PCT No.: PCT/CN2021/126281

§ 371 Date: Mar. 25, 2024

(51) Int. Cl. G06F 11/07

(52) U.S. Cl. CPC G06F 11/0751; G06F 11/0709; G06F 11/0787

(57) ABSTRACT

The present disclosure proposes a method, apparatus and computer program product for performing hardware failure detection based on multimodal feature fusion. A set of hardware event logs of a machine may be obtained, the machine including multiple hardware components. A set of performance signals of the machine may be obtained, the set of performance signals being time-series data. At least one failed hardware component in the machine may be detected based on the set of hardware event logs and the set of performance signals.

### BACKGROUND

With the development of technologies such as cloud storage and cloud computing, more and more enterprises and institutions leverage cloud services for daily operations and management. The cloud services may refer to a wide range of services delivered on demand over the Internet. The cloud services are managed by cloud service providers and made available to customers from the providers' machines, e.g., cloud servers, so there's no need for customers to host applications or resources on their own on-premises servers. In order to provide reliable cloud services, the cloud service providers usually perform hardware failure detection on the machines to timely detect failed hardware components in the machines and take proper remediation actions.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure propose a method, apparatus and computer program product for performing hardware failure detection based on multimodal feature fusion. A set of hardware event logs of a machine may be obtained, the machine including multiple hardware components. A set of performance signals of the machine may be obtained, the set of performance signals being time-series data. At least one failed hardware component in the machine may be detected based on the set of hardware event logs and the set of performance signals.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates an exemplary process for performing hardware failure detection based on multimodal feature fusion according to an embodiment of the present disclosure.

FIG. 2 illustrates an exemplary process for generating a log embedding according to an embodiment of the present disclosure.

FIG. 3 illustrates an exemplary process for generating a performance signal embedding according to an embodiment of the present disclosure.

FIG. 4 illustrates an exemplary process for generating an observation feature vector according to an embodiment of the present disclosure.

FIG. 5 illustrates an exemplary process for obtaining a training dataset for a hardware failure detection model according to an embodiment of the present disclosure.

FIG. 6 illustrates an exemplary process for collecting a set of historical performance signals according to an embodiment of the present disclosure.

FIG. 7 is a flowchart of an exemplary method for performing hardware failure detection based on multimodal feature fusion according to an embodiment of the present disclosure.

FIG. 8 illustrates an exemplary apparatus for performing hardware failure detection based on multimodal feature fusion according to an embodiment of the present disclosure.

FIG. 9 illustrates an exemplary apparatus for performing hardware failure detection based on multimodal feature fusion according to an embodiment of the present disclosure.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

At present, hardware failure detection may be performed through rule-based approaches. The rule-based approaches may detect failed hardware components in machines based on some predetermined rules. The predetermined rules are usually set by humans based on past experiences, and may rely only on strong signals related to serious failures. Thus, they may be not sufficient and accurate. Accordingly, the hardware failure detection employing the rule-based approaches may not cover all hardware issues and there are still some hardware issues needed to be handled manually. Performing the hardware failure detection in a more efficient way is desired.

Embodiments of the present disclosure propose machine learning based hardware failure detection. The proposed hardware failure detection may be performed through a machine learning model. Herein, a machine learning model for performing hardware failure detection may be referred to as a hardware failure detection model. The hardware failure detection model may detect at least one failed hardware component in a machine based on multimodal feature fusion. Herein, a machine may refer to various types of electronic devices with computing or information processing capabilities, e.g., a server, a computer, a cellphone, etc. For example, the hardware failure detection model may detect the failed hardware component in the machine based on both hardware event logs of the machine and performance signals of the machine. The hardware event logs may include multiple lines of logs related to various hardware events of the machine. The performance signals may include time-series data related to the performance of the machine. The hardware failure detection model may generate a log embedding based on the hardware event logs, generate a performance signal embedding based on the performance signals, and detect the failed hardware component based on the log embedding and the performance signal embedding.

Since the proposed hardware failure detection considers both the hardware event logs and the performance signals, it can provide more robust hardware failure detection results. Moreover, considering both the hardware event logs and the performance signals can facilitate to implicitly infer the root cause of hardware failure from the performance interaction between multiple hardware components. Furthermore, the number of detected failed hardware components and the number of corresponding failed machines will be very small. In this case, even if the number of machines is greatly increased, the proposed hardware failure detection can well handle, and thus the proposed hardware failure detection is a scalable solution.

In an aspect, the embodiments of the present disclosure propose to generate the log embedding through a pattern-level embedding approach. For example, a pattern of each hardware event log in a set of hardware event logs may be identified from a set of predetermined patterns based on regular expressions and/or longest common subsequence detection. The log embedding may be generated based on the identified patterns. Through the pattern-level embedding approach, the set of hardware event logs may be expressed in a high-quality embedding, which can facilitate to improve the generalization ability and the prediction accuracy of the hardware failure detection model.

In another aspect, the embodiments of the present disclosure propose to generate the performance signal embedding through transforming a set of performance signals from a time domain to a frequency domain, and extract feature vectors from frequency spectrum of the set of performance signals. Different hardware component failures may produce interruption signals with different frequencies, so a frequency spectrum of a performance signal may be different for different types of hardware component failures. Trough processing the frequency spectrum, the performance signal may be expressed in a precise and representative feature vector, which can facilitate to improve the prediction accuracy of the hardware failure detection model.

In yet another aspect, the embodiments of the present disclosure propose to train the hardware failure detection model with a training dataset obtained from historical hardware failure data. The training dataset may include a set of hardware replacement tickets, and a set of historical hardware event logs and a set of historical performance signals corresponding to the set of hardware replacement tickets. Herein, a hardware replacement ticket may be referred to as a ticket indicating which hardware component is failed and is to be replaced. The amount of the historical performance signals is huge. In order to collect appropriate historical performance signals from the huge number of historical performance signals, the embodiments of the present disclosure propose to collect the set of historical performance signals through a heuristic iterative procedure.

In still another aspect, the embodiments of the present disclosure propose to filter out low confidence tickets from the set of hardware replacement tickets, so as to improve the quality of the training dataset. Herein, a low confidence ticket may refer to a low quality ticket, such as a ticket which does not bring a machine back to service. The low confidence tickets may be filtered out through failure event timeline analysis. For example, only the last hardware replacement ticket among one or more hardware replacement tickets within a predetermined time period which brings a machine back to service may be treated as a ground truth label, while other hardware replacement tickets within the predetermined time period should be regarded as low confidence tickets and thus be filtered out.

It should be appreciated that although the foregoing discussion and the following discussion may involve examples of performing hardware failure detection on machines providing cloud services, the embodiments of the present disclosure are not limited to this, but may perform hardware failure detection on any other machine, such as an on-premises server, a personal computer, etc., in a similar manner.

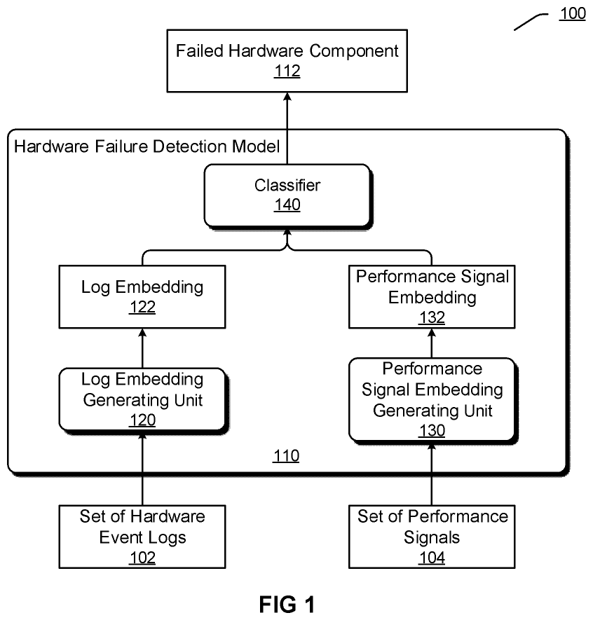

FIG. 1 illustrates an exemplary process 100 for performing hardware failure detection based on multimodal feature fusion according to an embodiment of the present disclosure. Through the process 100, at least one failed hardware component in a machine may be detected. The machine may be a server providing cloud services, an on-premises server, a personal computer, etc. The machine may include multiple hardware components, such as Central Processing Unit (CPU), memory, network card, Field Programmable Gate Array (FPGA) device, input/output module, etc. In the process 100, the hardware failure detection may be performed through a hardware failure detection model 110. The hardware failure detection model 110 may obtain a set of hardware event logs 102 and a set of performance signals 104 of the machine, and then detect at least one failed hardware component 112 in the machine.

The set of hardware event logs 102 may include multiple lines of logs related to various hardware events of the machine. The hardware events may include, e.g., CPU at low frequency, CPU issuing a high temperature alarm, etc. The hardware event log may be unstructured data, such as a segment in free text. The set of hardware event logs 102 may be obtained from, e.g., a board management chip (BMC) of the machine. The set of hardware event logs 102 may be produced during a first time period. That is, the set of hardware event logs 102 may correspond to the first time period.

The set of performance signals 104 may include multiple types of performance signals, such as CPU utilization, memory throughput, memory refresh time, etc. The performance signal may be structured data, such as time-series data. The set of performance signals 104 may be obtained from, e.g., an operating system of the machine. The set of performance signals 104 may be produced during a second time period. That is, the set of performance signals 104 may correspond to the second time period.

Since the hardware event logs are usually sparser than the performance signals, preferably, the first time period corresponding to the set of hardware event logs 102 may be longer than the second time period corresponding to the set of performance signals 104. For example, the first time period may be 15 days, and the second time period may be 7 days. Preferably, the end time of the first time period may be aligned with the end time of the second time period.

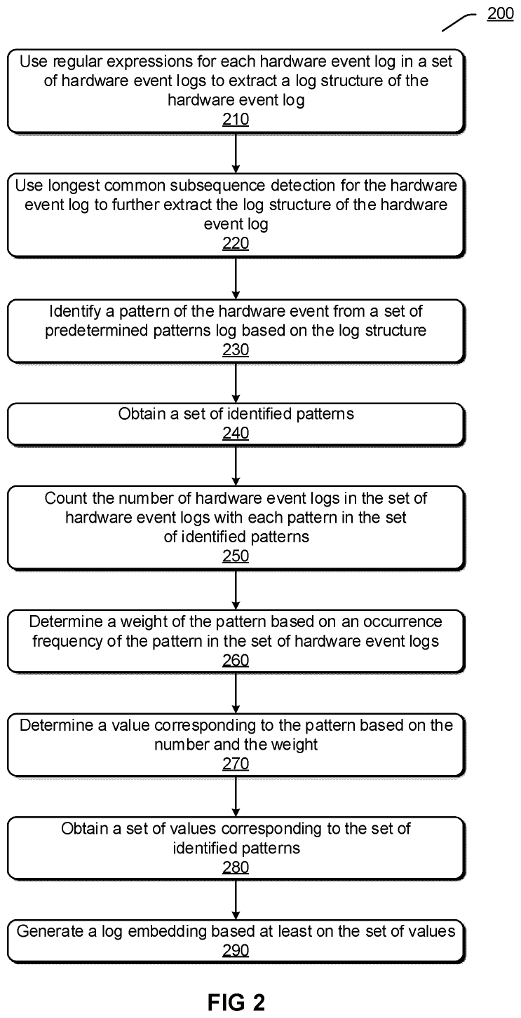

The hardware failure detection model 110 may include a log embedding generating unit 120. A log embedding 122 may be generated based on the set of hardware event logs 102 through the log embedding generating unit 120. An exemplary process for generating the log embedding 122 will be described in conjunction with FIG. 2.

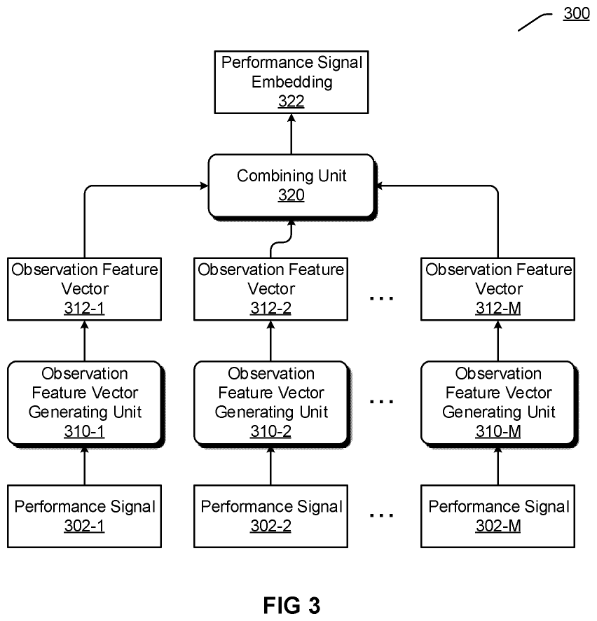

The hardware failure detection model 110 may include a performance signal embedding generating unit 130. A performance signal embedding 132 may be generated based on the set of performance signals 104 through the performance signal embedding generating unit 130. An exemplary process for generating the performance signal embedding 132 will be described in conjunction with FIG. 3.

The log embedding 122 and the performance signal embedding 132 may be provided to a classifier 140 in the hardware failure detection model 110. The classifier 140 may be a classifying model which is applicable to imbalanced dataset, such as XGBoost, an implementation of Gradient Boosted Decision Tree. The classifier 140 may detect at least one failed hardware component 112 in the machine based on the log embedding 122 and the performance signal embedding 132. For example, the classifier 140 may generate a probability distribution which indicates a probability that each hardware component is a failed hardware component, and output a hardware component with the highest probability.

In the process 100, the hardware failure detection model 110 may simultaneously consider both the hardware event logs and the performance signals, and thus it can provide more robust hardware failure detection results. For example, if only the hardware event logs are relied on, influence of weak signals in the hardware event logs may be ignored to achieve accurate hardware failure detection results, which increases the probability of false negatives in the hardware failure detection process. Herein, a weak signal may refer to a signal related to a non-critical failure event, such as CPU at low frequency, CPU issuing a high temperature alarm, etc. If only the performance signals are relied on, the hardware failure detection results are extremely susceptible to influence of upper-layer software service fluctuations, thereby increasing the probability of false positives. Therefore, considering both the hardware event logs and the performance signals can achieve more robust hardware failure detection results. Moreover, considering both the hardware event logs and the performance signals can facilitate to implicitly infer the root cause of hardware failure from the performance interaction between multiple hardware components. For example, a Dual Inline Memory Module (DIMM) failure may also affect the performance of the CPU. Furthermore, benefiting from the multimodal feature fusion, the number of detected failed hardware components and the number of corresponding failed machines will be very small. In this case, even if the number of machines is greatly increased, the proposed hardware failure detection can well handle, and thus the proposed hardware failure detection is a scalable solution.

It should be appreciated that the process 100 in FIG. 1 is only an example of the process for performing hardware failure detection based on multimodal feature fusion. According to actual application requirements, the steps in the process for performing hardware failure detection may be replaced or modified in any manner, and the process may comprise more or fewer steps. In addition, the specific order or hierarchy of the steps in the process 100 is only exemplary, and the process for hardware failure detection may be performed in an order different from the described order.

FIG. 2 illustrates an exemplary process 200 for generating a log embedding according to an embodiment of the present disclosure. The process 200 may correspond to the processing at the log embedding generating unit 120 in FIG. 1. Through the process 200, a log embedding may be generated based on a set of hardware event logs. The hardware event logs have quite different distribution from daily human language. The embodiments of the present disclosure propose to employ a pattern-level embedding approach to generate the log embedding, instead of using popular pre-trained model like Transformer or Bidirectional Encoder Representations from Transformers (BERT) for word-level embedding. The pattern-level embedding approach may be based on regular expressions and/or longest common sequence detection.

In the process 200, a pattern of each hardware event log in the set of hardware event logs may be identified from a set of predetermined patterns, to obtain a set of identified patterns. As an example, the set of predetermined patterns may include 41 different patterns, such as CPU at low frequency, CPU issuing a high temperature alarm, etc. When identifying a pattern of each hardware event log in the set of hardware event logs, regular expressions and/or longest common subsequence detection may be used for the hardware event log. Subsequently, a value corresponding to each pattern in the set of identified patterns may be determined, to obtain a set of values corresponding to the set of identified patterns. The log embedding may be generated based at least on the set of values.

At 210, regular expressions may be used for each hardware event log in the set of hardware event logs to extract a log structure of the hardware event log. Each hardware event log may include two parts, a log structure of the hardware event log and variant parameters of the hardware event log. According the embodiments of the present disclosure, the variant parameters of the hardware event log may be discarded while the log structure may be extracted, and the log structure may be used to determine a pattern of the hardware event log. Generally, continuous uppercase letters or continuous numbers are most likely to be variant parameters, e.g., physical address, serial number etc. Regular expressions may be used to filter variant parameters based on continuous uppercase letters or continuous numbers. Preferably, an allow list may be used to retain special professional abbreviations. The allow list may include, e.g., CPU, FPGA, etc.

At 220, longest common subsequence detection may be used for the hardware event log to further extract the log structure of the hardware event log. For example, the set of hardware event logs may be scanned. When a longest common subsequence of two lines of hardware event logs accounts for more than a predetermined percentage of original lengths of the hardware event logs, the longest common subsequence may be considered as the log structure of the two lines of hardware event logs. As an example, the predetermined percentage may be 80%. Trough using longest common subsequence detection, descriptive expressions may be removed from the log structure extracted at 210.

At 230, a pattern of the hardware event log may be identified from a set of predetermined patterns based on the log structure. As an example, the set of predetermined patterns may include 41 different patterns, such as CPU at low frequency, CPU issuing a high temperature alarm, etc. For example, the log structure of the hardware event log may be matched with the set of predetermined patterns, and a pattern with a highest matching degree may be considered as the identified pattern of the hardware event log.

The step 210 to the step 230 may be performed on all hardware event logs in the set of hardware event logs, and at 240, a set of identified patterns may be obtained.

Subsequently, a value corresponding to each pattern in the set of identified patterns may be determined. For example, at 250, the number of hardware event logs in the set of hardware event logs with each pattern in the set of identified patterns may be counted.

At 260, a weight of the pattern may be determined based on an occurrence frequency of the pattern in the set of hardware event logs. In an implementation, to emphasize the effect of rare hardware event logs which are usually important for hardware failure detection, the weight of the pattern may be determined through Inverse Document Frequency (IDF). For example, the weight Wᵢ of pattern i may be calculated as below:

$${W}_{i} = log \frac{\begin{matrix}Total number of hardware event logs \\ in the set of hardware event logs\end{matrix}}{( The number of hardware event logs with Pattern i ) + 1}$$

At 270, a value corresponding to the pattern may be determined based on the number of hardware event logs in the set of hardware event logs with the pattern and the weight of the pattern. For example, the value corresponding to the pattern may be calculated through multiplying the number by the weight.

The step 250 to the step 270 may be performed on all patterns in the set of identified patterns, and at 280, a set of values corresponding to the set of identified patterns may be obtained.

At 290, a log embedding of the set of hardware event logs may be generated based at least on the set of values. The log embedding may include values corresponding to the set of predetermined patterns. For example, when the set of predetermined patterns includes 41 different patterns, the log embedding may include 41 values corresponding to the 41 different patterns. The set of values obtained at 280 may correspond to the set of identified patterns. For patterns not included in the set of identified patterns, values corresponding to such patterns may be set as “0”.

Through the process 200 as described above, the set of hardware event logs may be expressed in a high-quality pattern-level embedding, which can facilitate to improve the generalization ability and the prediction accuracy of the hardware failure detection model. It should be appreciated that the process 200 in FIG. 2 is only an example of the process for generating a log embedding. According to actual application requirements, the steps in the process for generating a log embedding may be replaced or modified in any manner, and the process may comprise more or fewer steps. For example, although in the process 200, both regular expressions and longest common subsequence detection are used to extract the log structure of the hardware event log, it is also possible to use only one of regular expressions and longest common subsequence detection. In addition, the specific order or hierarchy of the steps in the process 200 is only exemplary, and the process for generating a log embedding may be performed in an order different from the described order.

FIG. 3 illustrates an exemplary process 300 for generating a performance signal embedding according to an embodiment of the present disclosure. The process 300 may correspond to the processing at the performance signal embedding generating unit 130 in FIG. 1. Through the process 300, a performance signal embedding may be generated based on a set of performance signals.

The set of performance signals may include a performance signal 302-1, a performance signal 302-2, . . . , a performance signal 302-M, wherein M is the number of performance signals in the set of performance signals.

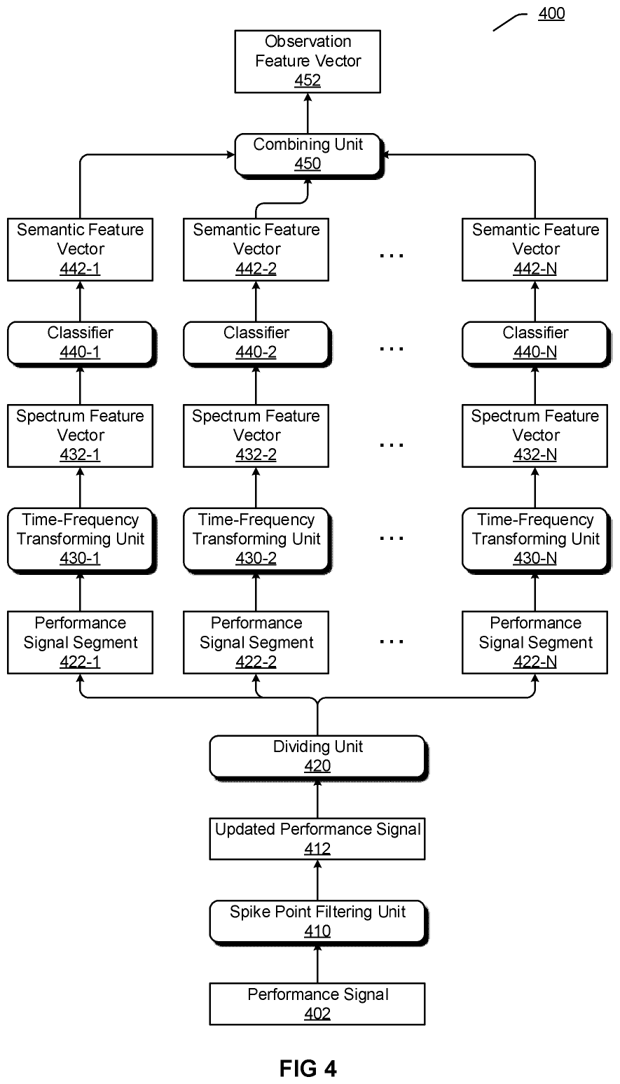

For each performance signal in the set of performance signals, an observation feature vector of the performance signal may be generated through a corresponding observation feature vector generating unit. For example, an observation feature vector 312-1 of the performance signal 302-1 may be generated through an observation feature vector generating unit 310-1, an observation feature vector 312-2 of the performance signal 302-2 may be generated through an observation feature vector generating unit 310-2, and an observation feature vector 312-M of the performance signal 302-M may be generated through an observation feature vector generating unit 310-M. An exemplary process for generating the observation feature vector will be described in conjunction with FIG. 4. Through the above process, a set of observation feature vectors corresponding to the set of performance signals may be obtained. The set of observation feature vectors may then be combined into a performance signal embedding 322 through a combining unit 320.

It should be appreciated that the process 300 in FIG. 3 is only an example of the process for generating a performance signal embedding. According to actual application requirements, the steps in the process for generating a performance signal embedding may be replaced or modified in any manner, and the process may comprise more or fewer steps. For example, in a case where there is only one performance signal, an observation feature vector of the performance signal may be directly regarded as the performance signal embedding. In addition, the specific order or hierarchy of the steps in the process 300 is only exemplary, and the process for generating a performance signal embedding may be performed in an order different from the described order.

FIG. 4 illustrates an exemplary process 400 for generating an observation feature vector according to an embodiment of the present disclosure. The process 400 may correspond to the processing at any one of the observation feature vector generating unit 310-1 to the observation feature vector generating unit 310-M in FIG. 3. Through the process 400, an observation feature vector 452 of a performance signal 402 may be generated. The performance signal 402 may correspond to any one of the performance signal 302-1 to the performance signal 302-M. The observation feature vector 452 may correspond to any one of the observation feature vector 312-1 to the observation feature vector 312-M.

Generally, when a hardware component fails, it sends interruption signals to the CPU and the CPU halts tasks to handle this issue. Therefore, the proportion of CPU time allocated to user processes will be reduced. Moreover, different hardware component failures may produce interruption signals with different frequencies, so a frequency spectrum of a performance signal may be different for different types of hardware component failures. The embodiments of the present disclosure propose to generate an observation feature vector through transforming a performance signal from a time domain to a frequency domain, and extract a feature vector from a frequency spectrum of the performance signal.

The performance signal 402 may include some spike points. Generally, the spike points are caused by issues from certain upper-layer softwares, rather than hardware failure. In view of this, when performing hardware failure detection, the spike points may be filtered out from the performance signal, so as to improve the robustness of the performance signal embedding. In the process 400, the spike points may be filtered out from the performance signal 402 through a spike point filtering unit 410, to obtain an updated performance signal 412. Compared with the performance signal 402, the updated performance signal 412 may be smoother. In an implementation, a Spectral Residual score may be calculated for each point in the performance signal 402, and a point whose Spectral Residual score is larger than most of other points may be considered as a spike point and thus be filtered out.

The updated performance signal 412 may be divided, through a dividing unit 420, into a plurality of performance signal segments, such as a performance signal segment 422-1, a performance signal segment 422-2, . . . , a performance signal segment 422-N, wherein N is the number of performance signal segments. For example, the updated performance signal 412 may include time-series data corresponding to a plurality of days. The updated performance signal 412 may be divided into a plurality of performance signal segments, each performance signal segment corresponding to a single day. Assuming that a sample frequency of performance signal is 5 minutes, each performance signal segment may include 288 points.

For each performance signal segment in the plurality of performance signal segments, a semantic feature vector of the performance signal segment may be generated, and thereby obtaining a plurality of semantic feature vectors corresponding to the plurality of performance signal segments. In an implementation, for each performance signal segment, a spectrum feature vector of the performance signal segment may be obtained through a corresponding time-frequency transforming unit. For example, a spectrum feature vector 432-1 of the performance signal segment 422-1 may be obtained through a time-frequency transforming unit 430-1, a spectrum feature vector 432-2 of the performance signal segment 422-2 may be obtained through a time-frequency transforming unit 430-2, and a spectrum feature vector 432-N of the performance signal segment 422-N may be obtained through a time-frequency transforming unit 430-N. The time-frequency transforming unit may transform the performance signal segment from a time domain to a frequency domain. As an example, the time-frequency transforming unit may transform the performance signal segment from a time domain to a frequency domain through performing Fourier Transform on the performance signal segment. As described above, each performance signal segment may include 288 points. Since the result of Fourier Transform is conjugate, only the first 144 points of each transform result may be taken into account. That is, a spectrum feature vector of a performance signal segment may include 144 amplitude values corresponding to the 144 points.

Subsequently, the spectrum feature vector may be translated into a semantic feature vector of the performance signal segment through a corresponding classifier. For example, the spectrum feature vector 432-1 may be translated into a semantic feature vector 442-1 of the performance signal segment through a classifier 440-1, the spectrum feature vector 432-2 may be translated into a semantic feature vector 442-2 of the performance signal segment through a classifier 440-2, and the spectrum feature vector 432-N may be translated into a semantic feature vector 442-N of the performance signal segment through a classifier 440-N. As an example, the classifier may be a Support Vector Machine (SVM). The classifier may be previously trained based on spectrum feature vectors and corresponding high-quality labels from human check. In an implementation, the classifier may translate the spectrum feature vector including 144 amplitude values corresponding to 144 points into a semantic feature vector including a single semantic feature value.

After obtaining the plurality of semantic feature vectors, such as the semantic feature vector 442-1 to the semantic feature vector 442-N, the plurality of semantic feature vectors may then be combined into the observation feature vector 452 through a combining unit 450.

Through the process 400 as described above, the performance signal may be expressed in a precise and representative feature vector, which can facilitate to improve the prediction accuracy of the hardware failure detection model. It should be appreciated that the process 400 in FIG. 4 is only an example of the process for generating an observation feature vector. According to actual application requirements, the steps in the process for generating an observation feature vector may be replaced or modified in any manner, and the process may comprise more or fewer steps. In addition, the specific order or hierarchy of the steps in the process 400 is only exemplary, and the process for generating an observation feature vector may be performed in an order different from the described order.

As described above, at least one failed hardware component in a machine may be detected through a hardware failure detection model, such as the hardware failure detection model 110 in FIG. 1. The model used for detecting the failed hardware component online may be referred to as an online hardware failure detection model. The online hardware failure detection model may have been previously offline trained. The hardware failure detection model that is being trained offline may be referred to as an offline hardware failure detection model. The online hardware failure detection model and the offline hardware failure detection model may share the same model structure and parameters. The output of the online model may be used for training the offline model in the next round. The training of the hardware failure detection model may be conducted at a predetermined time interval. For example, the hardware failure detection model may be trained every one to three months. Preferably, when there is a serious problem with the hardware failure detection model, the hardware failure detection model may be retrained instantly with feedback of the serious problem, rather than waiting for the predetermined time interval.

Furthermore, at least one result of at least one remediation action corresponding to the at least one detected failed hardware component may be obtained. The at least one result may be used for retraining the hardware failure detection model. Generally, after detecting a failed hardware component in a machine, a remediation action may be performed based on the detected failed hardware component. For example, the remediation action may be based on whether the detected failed hardware component stores sensitive data. The sensitive data may include, e.g., user data, confidential data, etc. As an example, if the detected failed hardware component stores sensitive data, corresponding remediation actions may be to replace it and destroy it. In this case, it may be determined whether the detected failed hardware component is actually replaced, and training data may be generated based on the determination. The training data may be used for retraining the hardware failure detection model. As another example, if the detected failed hardware component does not store sensitive data, corresponding remediation actions may be replace it and return it to its manufacturer for testing. In this case, a testing result for the detected failed hardware component may be obtained. The testing result may indicate whether the detected failed hardware component is actually failed. Training data for retraining the hardware failure detection model may be generated based on the testing result.

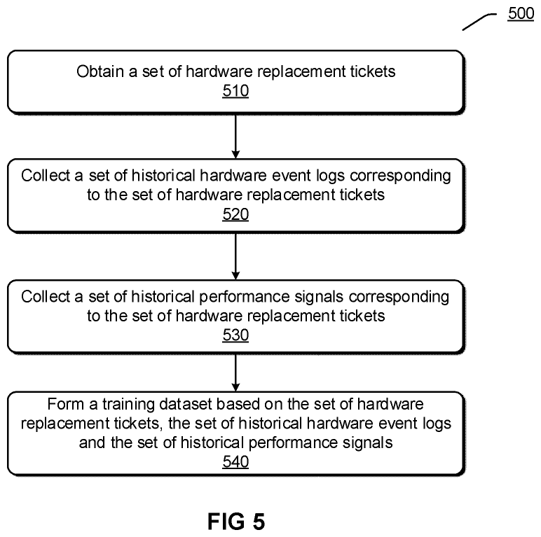

Additionally, a training dataset for the hardware failure detection model may be obtained from historical hardware failure data. The historical hardware failure data may include, e.g., hardware replacement tickets, historical hardware event logs, historical performance signals, etc. FIG. 5 illustrates an exemplary process 500 for obtaining a training dataset for a hardware failure detection model according to an embodiment of the present disclosure. In the process 500, hardware replacement tickets may be used to automatically label historical hardware event logs and historical performance signals.

At 510, a set of hardware replacement tickets may be obtained. The set of hardware replacement tickets may include a plurality of hardware replacement tickets created historically.

At 520, a set of historical hardware event logs corresponding to the set of hardware replacement tickets may be collected. For example, each hardware replacement ticket may have a timestamp. Historical hardware event logs corresponding to the hardware replacement ticket may be hardware event logs produced during a time period before the timestamp of the hardware replacement ticket.

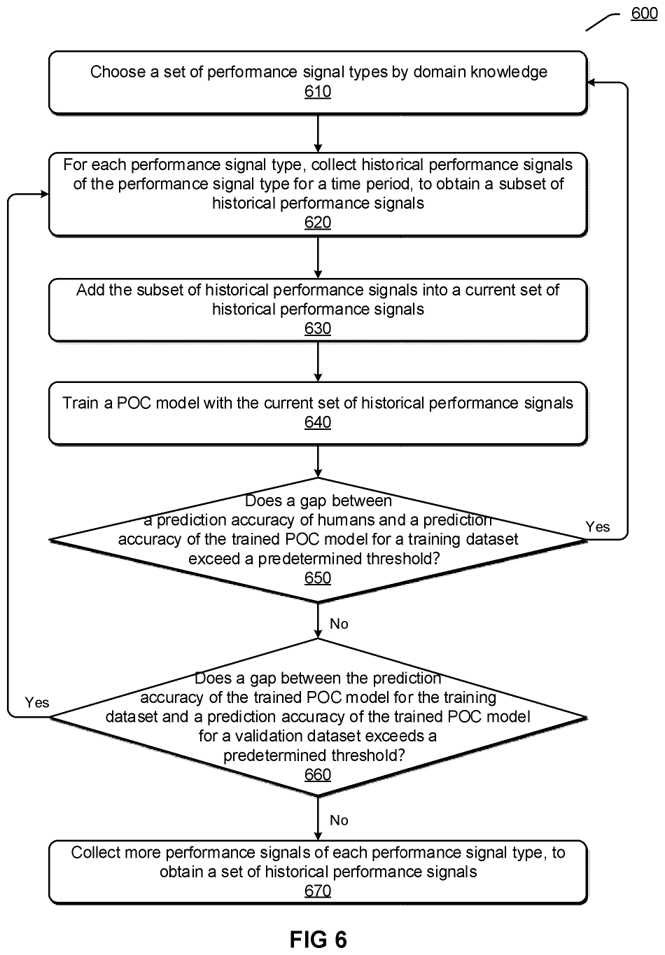

At 530, a set of historical performance signals corresponding to the set of hardware replacement tickets may be collected. Historical performance signals corresponding to a hardware replacement ticket may be performance signals produced during a time period before the timestamp of the hardware replacement ticket. Different from the historical hardware event logs, there are many types of historical performance signals, and thus the amount of the historical performance signals is huge. Efficiently collecting appropriate historical performance signals from the huge number of historical performance signals is desirable. The embodiments of the present disclosure propose to collect the set of historical performance signals through a heuristic iterative procedure. An exemplary process for collecting a set of historical performance signals will be described in conjunction with FIG. 6. Since performance signals are usually denser than hardware event logs, preferably, the time period corresponding to the set of historical performance signals may be shorter than the time period corresponding to the set of historical hardware event logs.

At 540, a training dataset may be formed based on the set of hardware replacement tickets, the set of historical hardware event logs and the set of historical performance signals. The training dataset may include multiple training samples. Each training sample may include a hardware replacement ticket, a plurality of historical hardware event logs corresponding to the hardware replacement ticket, and a plurality of historical performance signals corresponding to the hardware replacement ticket, wherein the hardware replacement ticket may be considered as a ground truth label of the training sample.

It should be appreciated that the process 500 in FIG. 5 is only an example of the process for obtaining a training dataset for a hardware failure detection model. According to actual application requirements, the steps in the process for obtaining a training dataset for a hardware failure detection model may be replaced or modified in any manner, and the process may comprise more or fewer steps. In addition, the specific order or hierarchy of the steps in the process 500 is only exemplary, and the process for obtaining a training dataset for a hardware failure detection model may be performed in an order different from the described order. For example, the step for collecting the set of historical performance signals may be performed before the step for collecting the set of historical hardware event logs.

Preferably, when obtaining a training dataset for a hardware failure detection model, in order to improve the quality of the training dataset, low confidence tickets may be filtered out from the set of hardware replacement tickets. Generally, it is very rare for a machine to have multiple failed hardware components at the same time. The embodiments of the present disclosure propose to filter out low confidence tickets through failure event timeline analysis. For example, only the last hardware replacement ticket among one or more hardware replacement tickets within a predetermined time period which brings a machine back to service may be treated as a ground truth label, while other hardware replacement tickets within the predetermined time period may be regarded as low confidence tickets and thus be filtered out. The predetermined time period may be, e.g., 15 days. As an example, if the machine is not back to service after a hardware replacement ticket is resolved, the hardware replacement ticket may be regarded as a low confidence ticket and thus be filtered out. As another example, if after a hardware replacement ticket is resolved, a new hardware replacement ticket is created later within the predetermined time period to bring the machine back to service, the previous hardware replacement ticket may be regarded as a low confidence ticket and thus be filtered out, even if the ticket has brought the machine back to service.

After filtering out the low confidence tickets from the set of hardware replacement tickets, the set of hardware replacement tickets may be updated. Accordingly, when obtaining the training dataset for the hardware failure detection model, a set of historical hardware event logs corresponding to the updated set of hardware replacement tickets may be collected, and a set of historical performance signals corresponding to the updated set of hardware replacement tickets may be collected. The training dataset may be formed based on the updated set of hardware replacement tickets, the set of historical hardware event logs and the set of historical performance signals.

FIG. 6 illustrates an exemplary process 600 for collecting a set of historical performance signals according to an embodiment of the present disclosure. The set of historical performance signals may be used for forming a training dataset for a hardware failure detection model. The process 600 may correspond to the step 530 in FIG. 5. In the process 600, a heuristic iterative procedure may be employed to collect the set of historical performance signals.

At 610, a set of performance signal types may be chosen by domain knowledge. Herein, domain knowledge may refer to a broad-based understanding of a particular hardware failure. For example, for each hardware replacement ticket in the set of hardware replacement tickets, one or more performance signal types related to the hardware replacement ticket may be chosen by domain knowledge. As an example, for the DIMM failure, the chosen set of performance signal types may include, e.g., CPU utilization, memory throughput, etc.

At 620, for each performance signal type, historical performance signals of the performance signal type may be collected for a time period, e.g., a few weeks, to obtain a subset of historical performance signals. In the subset of historical performance signals, a hardware replacement ticket corresponding to one or more historical performance signals may be a label of the one or more historical performance signals.

At 630, the subset of historical performance signals may be added into a current set of historical performance signals.

At 640, a proof-of-concept (POC) model may be trained with the current set of historical performance signals. The POC model may be a lightweight machine learning model, which can predict one or more failed hardware components based on the current set of historical performance signals.

Subsequently, error analysis may be performed on the trained proof-of-concept model. The error analysis can indicate whether the current set of historical performance signals is sufficient. Accordingly, the current set of historical performance signals may be augmented based on the error analysis, to obtain the set of historical performance signals.

For example, at 650, a gap between a prediction accuracy of humans and a prediction accuracy of the trained proof-of-concept model for a training dataset may be determined, and it may be determined whether the gap exceeds a predetermined threshold. Such gap can indicate how well labels can be classified in the signal space.

If it is determined at 650 that the gap between the prediction accuracy of humans and the prediction accuracy of the trained POC model for the training dataset exceeds the predetermined threshold, the set of performance signal types may be not sufficient, and may be extended. Thus the process 600 may return back to the step 610 to choose more performance signal types. For example, in the case where the CPU utilization and the memory throughput have been chosen, the memory refresh time, the memory clear time, etc., may also be chosen at this point.

If it is determined at 650 that the gap between the prediction accuracy of humans and the prediction accuracy of the trained proof-of-concept model for the training dataset does not exceed the predetermined threshold, the process 600 may proceed to a step 660. At 660, a gap between the prediction accuracy of the trained POC model for the training dataset and a prediction accuracy of the trained POC model for a validation dataset may be determined, and it may be determined whether the gap exceeds a predetermined threshold. Such gap can indicate how general the POC model expresses the performance signals.

If it is determined at 660 that the gap between the prediction accuracy of the trained POC model for the training dataset and the prediction accuracy of the trained POC model for the validation dataset exceeds the predetermined threshold, the data amount of the historical performance signals may be not sufficient, and data amount of at least one performance signal type in the set of performance signal types may be increased. Thus the process 600 may return back to the step 620 to collect more historical performance signals of the performance signal types.

If it is determined at 660 that the gap between the prediction accuracy of the trained POC model for the training dataset and the prediction accuracy of the trained POC model for the validation dataset does not exceed the predetermined threshold, the process 600 may proceed to a step 670. At 670, more performance signals of each performance signal type in the set of performance signal types may be collected, to obtain a set of historical performance signals. For example, during the next one to three months, performance signals of each performance signal type in the set of performance signal types may be collected on a large scale. The set of historical performance signals may be used for forming the training dataset for the hardware failure detection model.

It should be appreciated that the process 600 in FIG. 6 is only an example of the process for collecting a set of historical performance signals. According to actual application requirements, the steps in the process for collecting a set of historical performance signals may be replaced or modified in any manner, and the process may comprise more or fewer steps. In addition, the specific order or hierarchy of the steps in the process 600 is only exemplary, and the process for collecting a set of historical performance signals may be performed in an order different from the described order.

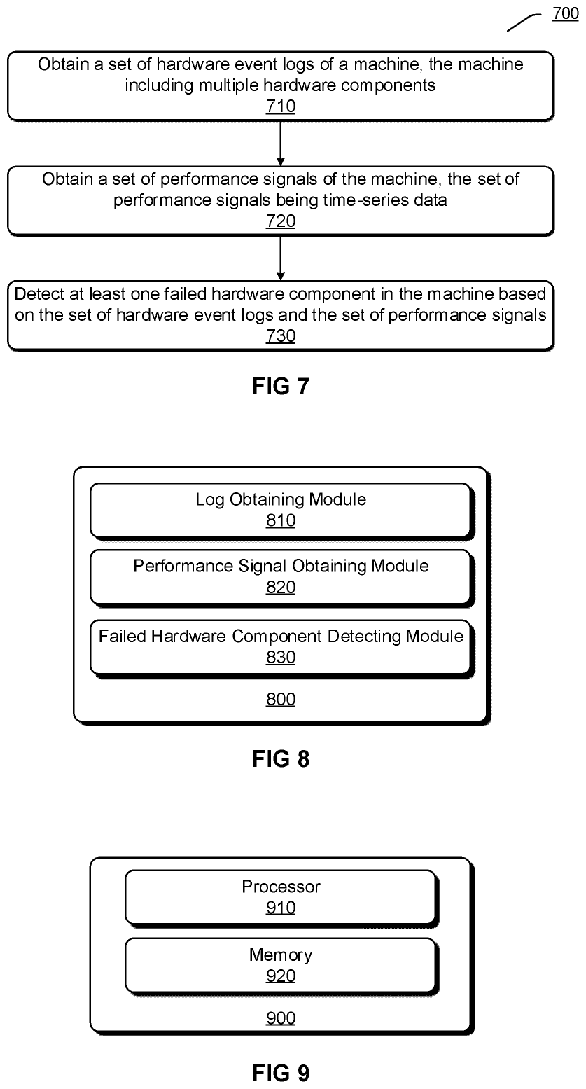

FIG. 7 is a flowchart of an exemplary method 700 for performing hardware failure detection based on multimodal feature fusion according to an embodiment of the present disclosure.

At 710, a set of hardware event logs of a machine may be obtained, the machine including multiple hardware components.

At 720, a set of performance signals of the machine may be obtained, the set of performance signals being time-series data.

At 730, at least one failed hardware component in the machine may be detected based on the set of hardware event logs and the set of performance signals.

In an implementation, the set of hardware event logs may correspond to a first time period. The set of performance signals may correspond to a second time period. The end time of the first time period may be aligned with the end time of the second time period.

In an implementation, the detecting at least one failed hardware component may comprise: generating a log embedding based on the set of hardware event logs; generating a performance signal embedding based on the set of performance signals; and detecting the at least one failed hardware component based on the log embedding and the performance signal embedding.

The generating a log embedding may comprise: identifying a pattern of each hardware event log in the set of hardware event logs from a set of predetermined patterns, to obtain a set of identified patterns; determining a value corresponding to each pattern in the set of identified patterns, to obtain a set of values corresponding to the set of identified patterns; and generating the log embedding based at least on the set of values.

The identifying a pattern of each hardware event log may comprise: identifying the pattern of the hardware event log through using regular expressions and/or longest common subsequence detection for the hardware event log.

The determining a value corresponding to each pattern may comprise: counting the number of hardware event logs in the set of hardware event logs with the pattern; determining a weight of the pattern based on an occurrence frequency of the pattern in the set of hardware event logs; and determining the value based on the number and the weight.

The generating a performance signal embedding may comprise: generating an observation feature vector of each performance signal in the set of performance signals, to obtain a set of observation feature vectors corresponding to the set of performance signals; and combining the set of observation feature vectors into the performance signal embedding.

The generating an observation feature vector of each performance signal may comprise: filtering out spike points in the performance signal, to obtain an updated performance signal; dividing the updated performance signal into a plurality of performance signal segments; generating a semantic feature vector of each performance signal segment in the plurality of performance signal segments, to obtain a plurality of semantic feature vectors corresponding to the plurality of performance signal segments; and combining the plurality of semantic feature vectors into the observation feature vector.

The generating a semantic feature vector of each performance signal segment may comprise: obtaining a spectrum feature vector of the performance signal segment through transforming the performance signal segment from a time domain to a frequency domain; and translating the spectrum feature vector into the semantic feature vector of the performance signal segment through a classifier.

In an implementation, the at least one failed hardware component may be detected through a hardware failure detection model. The training of the hardware failure detection model may comprise at least obtaining a training dataset for the hardware failure detection model from historical hardware failure data.

The obtaining a training dataset for the hardware failure detection model may comprise: obtaining a set of hardware replacement tickets; collecting a set of historical hardware event logs corresponding to the set of hardware replacement tickets; collecting a set of historical performance signals corresponding to the set of hardware replacement tickets; and forming the training dataset based on the set of hardware replacement tickets, the set of historical hardware event logs and the set of historical performance signals.

The collecting a set of historical performance signals may comprise: choosing a set of performance signal types by domain knowledge; for each performance signal type, collecting historical performance signals of the performance signal type for a time period, to obtain a subset of historical performance signals; adding the subset of historical performance signals into a current set of historical performance signals; training a proof-of-concept model with the current set of historical performance signals; performing error analysis on the trained proof-of-concept model; and augmenting the current set of historical performance signals based on the error analysis, to obtain the set of historical performance signals.

The performing error analysis on the trained proof-of-concept model may comprise: determining a gap between a prediction accuracy of humans and a prediction accuracy of the trained proof-of-concept model for a training dataset. The augmenting the current set of historical performance signals may comprise: extending the set of performance signal types in response to determining the gap exceeds a predetermined threshold.

The performing error analysis on the trained proof-of-concept model may comprise: determining a gap between a prediction accuracy of the trained proof-of-concept model for a training dataset and a prediction accuracy of the trained proof-of-concept model for a validation dataset. The augmenting the current set of historical performance may comprise: increasing data amount of at least one performance signal type in the set of performance signal types in response to determining the gap exceeds a predetermined threshold.

The method 700 may further comprise: filtering out low confidence tickets from the set of hardware replacement tickets.

In an implementation, the method 700 may further comprise: obtaining at least one result of at least one remediation action corresponding to the at least one detected failed hardware component; and retraining a hardware failure detection model based on the at least one result.

It should be appreciated that the method 700 may further comprise any steps/processes for performing hardware failure detection based on multimodal feature fusion according to the embodiments of the present disclosure as mentioned above.

FIG. 8 illustrates an exemplary apparatus 800 for performing hardware failure detection based on multimodal feature fusion according to an embodiment of the present disclosure.

The apparatus 800 may comprise: a log obtaining module 810, for obtaining a set of hardware event logs of a machine, the machine including multiple hardware components; a performance signal obtaining module 820, for obtaining a set of performance signals of the machine, the set of performance signals being time-series data; and a failed hardware component detecting module 830, for detecting at least one failed hardware component in the machine based on the set of hardware event logs and the set of performance signals.

It should be appreciated that the apparatus 800 may further comprise any other modules configured for performing hardware failure detection based on multimodal feature fusion according to the embodiments of the present disclosure as mentioned above.

FIG. 9 illustrates an exemplary apparatus 900 for performing hardware failure detection based on multimodal feature fusion according to an embodiment of the present disclosure.

The apparatus 900 may comprise at least one processor 910. The apparatus 900 may further comprise a memory 920 connecting with the processor 910. The memory 920 may store computer-executable instructions that, when executed, cause the processor 910 to obtain a set of hardware event logs of a machine, the machine including multiple hardware components, obtain a set of performance signals of the machine, the set of performance signals being time-series data, and detect at least one failed hardware component in the machine based on the set of hardware event logs and the set of performance signals.

In an implementation, the detecting at least one failed hardware component may comprise: generating a log embedding based on the set of hardware event logs; generating a performance signal embedding based on the set of performance signals; and detecting the at least one failed hardware component based on the log embedding and the performance signal embedding.

In an implementation, the at least one failed hardware component may be detected through a hardware failure detection model. The training of the hardware failure detection model may comprise at least obtaining a training dataset for the hardware failure detection model from historical hardware failure data.

It should be appreciated that the memory 920 may further store computer-executable instructions that cause the processor 910 to perform any other operations of the methods for performing hardware failure detection based on multimodal feature fusion according to the embodiments of the present disclosure as mentioned above.

The embodiments of the present disclosure propose a computer program product for performing hardware failure detection based on multimodal feature fusion, comprising a computer program that is executed by at least one processor for: obtaining a set of hardware event logs of a machine, the machine including multiple hardware components; obtaining a set of performance signals of the machine, the set of performance signals being time-series data; and detecting at least one failed hardware component in the machine based on the set of hardware event logs and the set of performance signals. Furthermore, the computer program may be further executed for implementing any other steps/processes of the methods for performing hardware failure detection based on multimodal feature fusion according to the embodiments of the present disclosure as mentioned above.

The embodiments of the present disclosure may be embodied in a non-transitory computer-readable medium. The non-transitory computer-readable medium may comprise instructions that, when executed, cause one or more processors to perform any operations of the methods for performing hardware failure detection based on multimodal feature fusion according to the embodiments of the present disclosure as mentioned above.

It should be appreciated that all the operations in the methods described above are merely exemplary, and the present disclosure is not limited to any operations in the methods or sequence orders of these operations, and should cover all other equivalents under the same or similar concepts. In addition, the articles “a” and “an” as used in this specification and the appended claims should generally be construed to mean “one” or “one or more” unless specified otherwise or clear from the context to be directed to a singular form.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout the present disclosure. The functionality of a processor, any portion of a processor, or any combination of processors presented in the present disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors, e.g., cache or register.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are intended to be encompassed by the claims.

What is claimed is:

1. A method for performing hardware failure detection based on multimodal feature fusion, comprising:
obtaining a set of hardware event logs of a machine, the machine including multiple hardware components;
obtaining a set of performance signals of the machine, the set of performance signals being time-series data; and
detecting at least one failed hardware component in the machine based on the set of hardware event logs and the set of performance signals.

2. The method of claim 1, wherein the set of hardware event logs corresponds to a first time period, the set of performance signals corresponds to a second time period, and the end time of the first time period is aligned with the end time of the second time period.

3. The method of claim 1, wherein the detecting at least one failed hardware component comprises:
generating a log embedding based on the set of hardware event logs;
generating a performance signal embedding based on the set of performance signals; and
detecting the at least one failed hardware component based on the log embedding and the performance signal embedding.

4. The method of claim 3, wherein the generating a log embedding comprises:
identifying a pattern of each hardware event log in the set of hardware event logs from a set of predetermined patterns, to obtain a set of identified patterns;
determining a value corresponding to each pattern in the set of identified patterns, to obtain a set of values corresponding to the set of identified patterns; and
generating the log embedding based at least on the set of values.

5. The method of claim 4, wherein the identifying a pattern of each hardware event log comprises:
identifying the pattern of the hardware event log through using regular expressions and/or longest common subsequence detection for the hardware event log.

6. The method of claim 4, wherein the determining a value corresponding to each pattern comprises:
counting the number of hardware event logs in the set of hardware event logs with the pattern;
determining a weight of the pattern based on an occurrence frequency of the pattern in the set of hardware event logs; and
determining the value based on the number and the weight.

7. The method of claim 3, wherein the generating a performance signal embedding comprises:
generating an observation feature vector of each performance signal in the set of performance signals, to obtain a set of observation feature vectors corresponding to the set of performance signals; and
combining the set of observation feature vectors into the performance signal embedding.

8. The method of claim 7, wherein the generating an observation feature vector of each performance signal comprises:
filtering out spike points in the performance signal, to obtain an updated performance signal;
dividing the updated performance signal into a plurality of performance signal segments;
generating a semantic feature vector of each performance signal segment in the plurality of performance signal segments, to obtain a plurality of semantic feature vectors corresponding to the plurality of performance signal segments; and
combining the plurality of semantic feature vectors into the observation feature vector.

9. The method of claim 8, wherein the generating a semantic feature vector of each performance signal segment comprises:
obtaining a spectrum feature vector of the performance signal segment through transforming the performance signal segment from a time domain to a frequency domain; and
translating the spectrum feature vector into the semantic feature vector of the performance signal segment through a classifier.

10. The method of claim 1, wherein the at least one failed hardware component is detected through a hardware failure detection model, and the training of the hardware failure detection model comprises at least obtaining a training dataset for the hardware failure detection model from historical hardware failure data.

11. The method of claim 10, wherein the obtaining a training dataset for the hardware failure detection model comprises:
obtaining a set of hardware replacement tickets;
collecting a set of historical hardware event logs corresponding to the set of hardware replacement tickets;
collecting a set of historical performance signals corresponding to the set of hardware replacement tickets; and
forming the training dataset based on the set of hardware replacement tickets, the set of historical hardware event logs and the set of historical performance signals.

12. The method of claim 11, wherein the collecting a set of historical performance signals comprises:
choosing a set of performance signal types by domain knowledge;
for each performance signal type, collecting historical performance signals of the performance signal type for a time period, to obtain a subset of historical performance signals;
adding the subset of historical performance signals into a current set of historical performance signals;
training a proof-of-concept model with the current set of historical performance signals;
performing error analysis on the trained proof-of-concept model; and
augmenting the current set of historical performance signals based on the error analysis, to obtain the set of historical performance signals.

13. The method of claim 12, wherein
the performing error analysis on the trained proof-of-concept model comprises: determining a gap between a prediction accuracy of humans and a prediction accuracy of the trained proof-of-concept model for a training dataset, and
the augmenting the current set of historical performance signals comprises: extending the set of performance signal types in response to determining the gap exceeds a predetermined threshold.

14. The method of claim 12, wherein
the performing error analysis on the trained proof-of-concept model comprises: determining a gap between a prediction accuracy of the trained proof-of-concept model for a training dataset and a prediction accuracy of the trained proof-of-concept model for a validation dataset, and
the augmenting the current set of historical performance comprises: increasing data amount of at least one performance signal type in the set of performance signal types in response to determining the gap exceeds a predetermined threshold.

15. The method of claim 11, further comprising:
filtering out low confidence tickets from the set of hardware replacement tickets.

16. The method of claim 1, further comprising:
obtaining at least one result of at least one remediation action corresponding to the at least one detected failed hardware component; and
retraining a hardware failure detection model based on the at least one result.

17. An apparatus for performing hardware failure detection based on multimodal feature fusion, comprising:
at least one processor; and
a memory storing computer-executable instructions that, when executed, cause the at least one processor to:
obtain a set of hardware event logs of a machine, the machine including multiple hardware components,
obtain a set of performance signals of the machine, the set of performance signals being time-series data, and
detect at least one failed hardware component in the machine based on the set of hardware event logs and the set of performance signals.

18. The apparatus of claim 17, wherein the detecting at least one failed hardware component comprises:
generating a log embedding based on the set of hardware event logs;
generating a performance signal embedding based on the set of performance signals; and
detecting the at least one failed hardware component based on the log embedding and the performance signal embedding.

19. The apparatus of claim 17, wherein the at least one failed hardware component is detected through a hardware failure detection model, and the training of the hardware failure detection model comprises at least obtaining a training dataset for the hardware failure detection model from historical hardware failure data.

20. A computer program product for performing hardware failure detection based on multimodal feature fusion, comprising a computer program that is executed by at least one processor for:
obtaining a set of hardware event logs of a machine, the machine including multiple hardware components;
obtaining a set of performance signals of the machine, the set of performance signals being time-series data; and
detecting at least one failed hardware component in the machine based on the set of hardware event logs and the set of performance signals.
